(19) United States
(12) Patent Application Publication
(10) Pub. No.: US 2011/0192432 A1
(43) Pub. Date: Aug. 11, 2011

(54) CLEANING AND DISINFECTING INSTRUMENT WITH ADJUSTABLE NOZZLE

(76) Inventors: Denis LEHMANN, Ortenberg (DE); Ingo Wiegand, Buehlertal (DE)

(21) Appl. No.: 13/031,441

(22) Filed: Feb. 21, 2011

Related U.S. Application Data
(63) Continuation of application No. PCT/EP2009/060817, filed on Aug. 21, 2009.

(30) Foreign Application Priority Data
Aug. 21, 2008 (DE) 10 2008 039 160.3

(51) Int. Cl. B08B 3/00

(52) U.S. Cl. 134/198

(57) ABSTRACT

A cleaning and disinfection instrument for cleaning care utensils is provided. The cleaning and disinfection instrument includes a washing chamber for holding the care utensils and a spray system for applying a cleaning fluid onto the care utensils. The spray system has at least one nozzle for emitting at least one jet of the cleaning fluid. Here, a jet direction, at which the jet is emitted, can be set.

This nonprovisional application is a continuation of International Application No. PCT/EP2009/060817, which was filed on Aug. 21, 2009, and which claims priority to German Patent Application No. 10 2008 039 160.3, which was filed in Germany on Aug. 21, 2008, and which are both herein incorporated by reference.

### BACKGROUND OF THE INVENTION

1. Field of the Invention

The invention relates to a cleaning and disinfection instrument for medical ware and to a nozzle for use in such a cleaning and disinfection instrument. Such cleaning and disinfection instruments and such nozzles are used, in particular, in care establishments and hospitals for cleaning and disinfecting care utensils, such as medical ware, bedpans, urinal bottles or other care utensils, that have cavities for holding relatively large amounts of liquid. These are typically used in hospitals with care units and care establishments for the elderly. However, in principle, other areas of use are also possible.

2. Description of the Background Art

Care establishments such as hospitals or care homes for the elderly use cleaning and disinfection instruments (RDGs), in which care utensils such as bedpans, urinal bottles or other medical ware are cleaned and disinfected. These cleaning and disinfection instruments are, for example, available commercially with designs that have a front door, which can be opened toward the front as a result of a pivot movement through e.g. approximately 90° about a horizontal axis. However, other embodiments are also possible.

Such cleaning and disinfection instruments are known from the prior art and special embodiments thereof are for example described in DE 10 2005 026 088 A1, in DE 103 48 344 A1 (which corresponds to U.S. Publication No. 20070104608) or in DE 103 52 809 A1. All designs described therein may, for example, be referred to for a starting point for the invention described in the following text.

In order to operate the cleaning and disinfection instruments, the front door is usually opened in the forward direction. The care utensils or goods to be cleaned are inserted into a holder, the so-called vessel holder. By way of example, the vessel holder is attached onto the inside of the front door. An operator can subsequently close the front door by subjecting the latter to an upward pivot movement, and said operator may initiate a required cleaning program e.g. manually. After the cleaning program has been completed and after a successful disinfection, the front door can be opened such that the care utensils can once again be removed. However, in principle, other embodiment types of the cleaning and disinfection instruments and other embodiments of the operation are also possible.

Cleaning and disinfection instruments in most cases have one or more nozzles in the interior of a washing chamber in which the cleaning procedure takes place, which nozzles perform different functions during the cleaning procedure. Thus, for example, there are nozzles designed for cleaning the interior of the care utensils, for example the interior of the bedpans. Alternatively, or in addition thereto, nozzles can be provided for cleaning the exterior of the care utensils to be cleaned. Specific nozzles can likewise be provided for cleaning the interior of other types of care utensils, such as urinal bottles. These nozzles can be embodied such that a jet of the cleaning fluid emanating from these nozzles passes through a neck, e.g. a narrow neck, of the care utensils, e.g. the urinal bottles, and impinges on the base of the care utensils, e.g. the inner base of the urinal bottles. This jet of cleaning fluid then splashes on the inside of the base of the care utensils, and the cleaning fluid can wet, and hence clean, the entire inner surface of the care utensils.

However, a problem in this case is that if the jet does not impinge as prescribed on the interior of the care utensils, it must be expected that the care utensils are not properly cleaned. This would result in significant hygienic problems for the operator of the cleaning and disinfection instrument.

However, different types of care utensils, e.g. medical ware, are commercially available, and these may differ in terms of their materials, their shape and their dimensions. By way of example, in the case of urinal bottles this means that the angle of the neck of the urinal bottle with respect to the base body of the urinal bottle, and also the length of the entire bottle, may vary between models.

In order to compensate for these differences and obtain an optimum cleaning result for all care utensils, the producer generally fits the vessel holders to the respectively varying requirements during production in the factory. In extreme circumstances there even is the need for developing and producing new nozzles so that all requirements can be satisfied. However, this generally requires much effort in the development, during trials and in production in the case of each new customer order. Moreover, the effort in respect of storing spare parts is also non-negligible.

### SUMMARY OF THE INVENTION

In light of the sketched out disadvantages of the prior art, the present invention is based on the object of providing, by simple means, an option for satisfying the different requirements for the cleaning and disinfection instrument resulting from different types of goods to be cleaned in the form of care utensils. At the same time, the variety of parts that are used in production or used as spares should be reduced.

This object is achieved in an embodiment, by a cleaning and disinfection instrument and by a nozzle for use in such a cleaning and disinfection instrument.

A cleaning and disinfection instrument for cleaning care utensils is proposed. Here, a cleaning and disinfection instrument should be understood to mean a device that can subject the care utensils to a cleaning procedure in which at least one cleaning fluid can be used to free, at least for the most part, the care utensils from contaminants adhering to said care utensils and/or from contaminants taken up by said care utensils. Furthermore, the cleaning and disinfection instrument should also be designed to carry out at least one disinfection procedure, i.e. a procedure in which there is a reduction in the number of germs adhering to the care utensils. This reduction in the number of germs may be partial, but can also include a complete reduction in the number of germs within the scope of sterilization. By way of example, the disinfection procedure can take place using conventional disinfection media, more particularly using moist heat. By way of example, hot vapor can be used for the disinfection, and/or there could be a chemical disinfection and/or a thermal disinfection or a combination of the aforementioned methods and/or other methods, e.g. a combination of thermal and chemical disinfection methods.

In general, care utensils should be understood to mean utensils that can be used in the field of care for caring for human or animal patients. The term “care utensils” can be understood to mean both individual objects and also a plurality of objects. Thus, a cleaning and disinfection instrument can for example be used for cleaning an individual object from the field of care utensils, or there can be an apparatus for cleaning of a number of such objects from the field of care utensils at the same time.

The use is particularly preferred for care utensils that are suitable for holding relatively large amounts of waste materials, i.e. care utensils that at least in part are embodied as vessels. Such vessels preferably are vessels for liquid and/or solid waste material amounting to in the region of a few ml up to several 10 ml or several 100 ml. Typical examples of such care utensils are medical ware such as bedpans, urinal bottles or similar types of medical ware.

In accordance with the preferred embodiment for care utensils, which, as vessels, are provided for holding relatively large amounts of liquids, the cleaning and disinfection instrument can also be suitable for holding such relatively large amounts of liquid or solid waste materials. By way of example, the cleaning and disinfection instrument can, as described in e.g. DE 103 48 344 A1, which corresponds to U.S. Publication No. 20070104608, and which is incorporated herein by reference, have a drain, which, for example, can be connected to a drainage system in the building. This drain can also be embodied with a siphon bend, and so even relatively large amounts of solid and/or liquid waste material can easily be disposed of from the care utensils, for example waste material amounting to around 100 ml or more.

The cleaning and disinfection instrument comprises a washing chamber for holding the care utensils. By way of example, this washing chamber in turn can be embodied with at least one vessel holder for holding the care utensils. By way of example, this at least one vessel holder can in turn be coupled to a door of the washing chamber, for example, in turn, to a front door which can be opened up. However, in principle, other embodiments are also possible.

The cleaning and disinfection instrument furthermore comprises at least one spray system for applying a cleaning fluid onto the care utensils. Here, use can be made of liquid cleaning fluids in particular, for example water with or without additives such as e.g. a cleaning agent and/or a disinfectant.

The spray system comprises at least one nozzle, which is designed to emit at least one jet of the cleaning fluid. Here, a jet should be understood as meaning a focused amount of cleaning fluid that is substantially emitted in the same spatial direction. The solid angle at which the cleaning fluid is emitted is preferably smaller than 4π/10, more particularly smaller than 4π/50 and particularly preferably smaller than 4π/100. The spatial direction into which this jet is emitted is also referred to as jet direction in the following text.

According to the invention, it is proposed to embody the at least one nozzle or, if a plurality of nozzles are provided, at least one of these nozzles such that the jet direction, at which the jet is emitted by the nozzle, can be set.

The jet direction can preferably be set by hand. By way of example, the jet direction may be fixable after being set, for example after being set by hand. By way of example, a fastener may be provided for this purpose, which fastener allow fixing in a desired position of the jet direction, i.e. in a certain solid-angle position. By way of example, these fasteners can allow an adjustment of the jet direction in at least one first position of the fastener and can fix the jet direction in at least one second position of the fastener.

Thus, the proposed cleaning and disinfection instrument achieves the above-described object by virtue of the fact that the nozzle provided for cleaning the care utensils, e.g. the urinal bottle, is designed such that the direction of the jet can easily be set in an optimal fashion with respect to the requirements of the goods to be cleaned in the form of the care utensils, for example during an installation and/or operation of the cleaning and disinfection instrument.

By way of example, the nozzle may for this purpose have a multipart design. By way of example, the nozzle can comprise a nozzle assembly, which has at least one bore for supplying the cleaning fluid to the nozzle. By way of example, this nozzle assembly can be securely mounted on an internal wall of the washing chamber.

Furthermore, the nozzle can have an adjustable nozzle head, which can ensure the above-described adjustability of the jet direction. By way of example, this nozzle head can be mounted such that its angle with respect to one or more pivot axes can change. A gimbal mount and/or mounting by means of a ball-and-socket joint are also feasible. However, the nozzle head can at the same time be embodied such that it can be fastened, and so although the angular position can be set in one or more dimensions, it can be fixed by fastening the nozzle head as soon as the desired angular position has been set, and hence as soon as the desired jet direction has been set.

The cleaning fluid can be supplied through at least one bore in the interior of the nozzle assembly. Then the jet can be formed in the interior of the nozzle head, and it can be emitted into the washing chamber and onto the care utensils in a jet direction prescribed by the position of the nozzle head. The nozzle can also simultaneously emit a plurality of jets, wherein all jets can at the same time be adjustable in terms of their jet directions or else can be separately adjustable and separately fixable. In this respect too, the nozzle can have a multipart design.

As illustrated above, the nozzle can have a fastener, with, for example, the jet direction being adjustable in the at least one first position of the fastener and with the jet direction being able to be fixed in at least one second position of the fastener. By way of example, this fastener can be arranged on the nozzle assembly and/or on the nozzle head and/or at a transition between nozzle assembly and nozzle head, for example on a pivot joint. Other embodiments are also possible.

By way of example, the fastener can have at least one of the following devices: a screw, for example a wing screw or another type of screw; a split pin; a bolt; a latching device; a latching button, more particularly a spring-pretensioned latching button; a quick-release device. As an alternative to the aforementioned fastener, or in addition thereto, provision can also be made for combinations of the aforementioned and/or other types of fasteners. In particular, the fastener can be designed for permanently fixing the jet direction while the cleaning and disinfection instrument is in operation. This means that even during operation, conventional tremors or changes in the surrounding conditions do not substantially influence the jet direction.

Furthermore, the jet direction can be set over an adjustment range. By way of example, this adjustment range can be prescribed by a single angle in space and/or by a plurality of such angles, for example a polar angle and an azimuthal angle.

The nozzle can also be fixed in a plurality of predefined positions of the jet direction. Here, a plurality can be understood to mean two, three or more positions of the jet direction. By way of example, the latching device can have a separate latch at regular or irregular intervals on the angular scale or on the angular scales. By way of example, the nozzle can latch into respectively one position such that it can be clearly felt by an operator. The adjustment range can for example be subdivided into a plurality of predefined steps.

The nozzle, more particularly the aforementioned optional latching device, can be designed to make a selected position of the jet direction optically detectable for an operator. By way of example, this can be brought about by virtue of the fact that the nozzle, more particularly the latching device, comprises a display that indicates the selected position of the jet direction. By way of example, this display can be a scale, from which the operator can read the respective position of the jet direction. However, in principle, other types of displays are also possible, for example mechanical and/or electrical display. Transmission to a control of the cleaning and disinfection instrument is also possible, and so, for example, the position of the jet direction can also be made optically detectable for an operator on a display of the control.

In a further embodiment of the cleaning and disinfection instrument, the nozzle comprises at least one fixed part and at least one adjustable part. The fixed part can, for example, be the above-described at least one nozzle assembly, and the adjustable part can, for example, be the at least one nozzle head. In this case, it is particularly preferable for at least one labyrinth seal to be provided between the fixed part and the adjustable part. Here a labyrinth seal is understood to mean a seal, more particularly a contactless seal, in which an extended sealing path is based on an interaction between rings or ribs and/or grooves between the two parts that should be sealed with respect to one another. By way of example, the nozzle assembly and the nozzle head can each have one or more such rings and/or grooves that engage in one another such that the sealing effect is provided by an extended sealing path.

The nozzle can be produced from a multiplicity of materials. Thus, the nozzle, for example the nozzle head and/or the nozzle assembly, can for example comprise at least one of the following materials: a metallic material; a plastic. More particularly, it is preferred if the nozzle is wholly or partly produced by a shaping method, in which bodies are produced directly from three-dimensional computer data. Examples of such shaping methods are CNC milling, rapid-prototyping methods, e-manufacturing methods or similar shaping methods.

In addition to the cleaning and disinfection instrument as per one or more of the above-described variants, the invention furthermore relates to a nozzle for use in a spray system of such a cleaning and disinfection instrument. In respect of possible embodiments of the nozzle, reference can be made in this case to the above-described possible embodiments of the cleaning and disinfection instrument that respectively relate to the nozzle. The nozzle should be designed to emit at least one jet of the cleaning fluid, wherein the jet direction, at which the jet is emitted, should be able to be set and should preferably be able to be fixed. In respect of further possible embodiments, reference can be made to the above description.

Compared to devices of this type known from the prior art, the cleaning and disinfection instrument and the nozzle for use in a spray system of this cleaning and disinfection instrument have a multiplicity of advantages. Thus, for example, a fitter can, during the fitting and/or when the cleaning and disinfection instrument is put into operation, easily and quickly fit the cleaning and disinfection instrument to the respective conditions and requirements of a customer. It is also possible to change the settings if the type of medical ware is changed. Here, the setting can be brought about manually or else in an automated fashion, for example by means of one or more drives. In the process, the setting facility can be embodied such that the washing chamber has to be opened for applying these settings, for example by opening a front panel. Alternatively, or in addition thereto, a setting can also be applied by appropriate controls, for example by entering appropriate control commands into such controls. This also allows, for example by means of one or more electrical and/or mechanical drives, the setting of the jet angle to be applied, for example for enabling quick adaptation to other types of care utensils. By way of example, a list of care utensils can also be stored in a control such that, for example, the control automatically applies suitable settings of the jet direction for a certain type of care utensils. Various embodiments are feasible.

Hence, the proposed cleaning and disinfection instrument furthermore also reduces production and installation complexity. Furthermore, storage costs can be drastically reduced since, for example, the number of nozzles stored for certain jet-direction angular positions can be reduced to a minimum, preferably to a single nozzle that can be set. This thus affords the possibility of obtaining significant production advantages and logistical advantages.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a cleaning and disinfection instrument according to the invention, in a partly cut-open illustration with an opened front-side hinged door;

FIG. 2 shows a schematic illustration of the cleaning and disinfection instrument as per FIG. 1 with a closed front-side hinged door and the spray system in a partly cut-open illustration; and

FIGS. 3a and 3b show an exemplary embodiment of a nozzle split in two in various positions of the jet direction.

### DETAILED DESCRIPTION

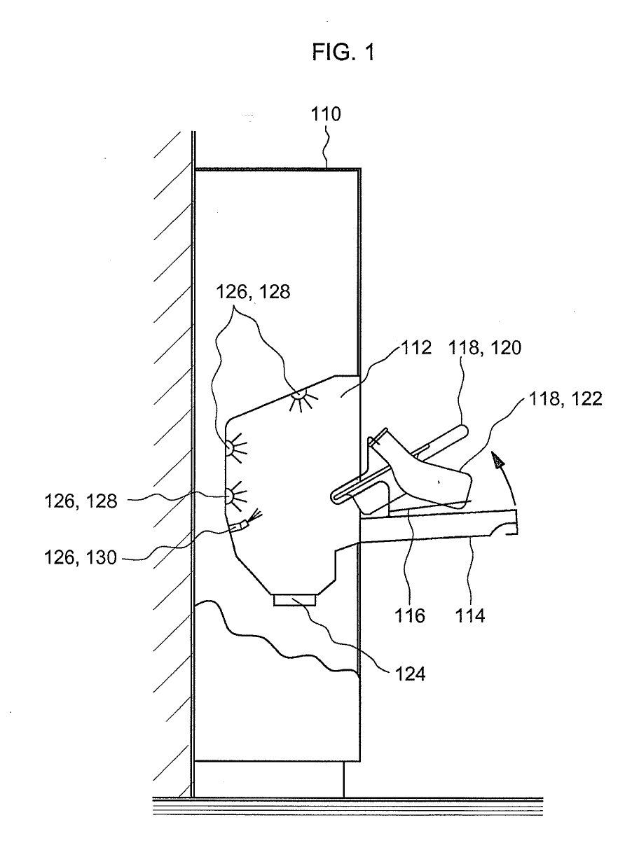

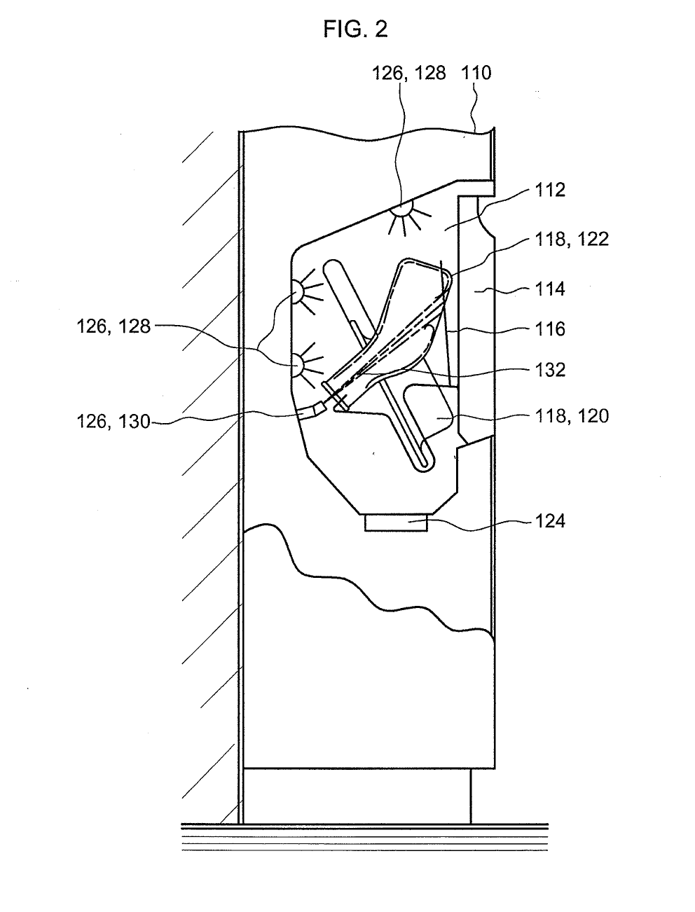

FIGS. 1 and 2 show a side view of an exemplary embodiment of a cleaning and disinfection instrument 110 in a partly cut-open illustration. The cleaning and disinfection instrument 110 has a washing chamber 112 with a front-side hinged door 114 as a washing chamber door. Here, FIG. 1 shows the cleaning and disinfection instrument 110 with an opened front-side hinged door 114, whereas FIG. 2 shows a position in which the front-side hinged door 114 is closed. Reference is made to the fact that there may also be other embodiments of the washing chamber 112 than the embodiments illustrated in FIGS. 1 and 2; for example, embodiments with a different type of door, for example with a door on a top side of the instrument or similar embodiments. However, the present embodiment is particularly preferred because a vessel holder 116 can be provided on the front-side hinged door 114, into which vessel holder one or more care utensils 118, illustrated in an exemplary fashion in this case in the form of a bedpan 120 and a urinal bottle 122, can be introduced. When the front-side hinged door 114 is closed, these care utensils 118 can be tilted such that these care utensils 118 can, at least to a large part, be freed from liquid and/or solid contents by emptying. These solid and/or liquid contents can be disposed of as waste materials by e.g. a drain 124, which is merely indicated in the figures. By way of example, the drain 124 may be provided with an odor barrier in the form e.g. of a siphon bend with a liquid barrier and can be connected to a corresponding drainage system.

A spray system 126 is provided in the interior of the washing chamber 112 and can be used to apply at least one cleaning fluid to the care utensils 118. In the present exemplary embodiment, this spray system 126 has a multipart design and comprises a plurality of individual nozzles 128, 130. Here, these nozzles 128, 130 are used for different purposes and are merely indicated symbolically in FIGS. 1 and 2. While the nozzles 128 can substantially be provided for cleaning the bedpan 120 and for cleaning the exterior of the care utensils 118 and can, for example, be embodied as non-adjustable nozzles, the nozzle 130 serves for cleaning the interior of the urinal bottle 122. According to the invention, this nozzle 130 is embodied as an adjustable nozzle, wherein provision can also be made for a plurality of such nozzles 130.

The functionality of the spray system 126 and the nozzles 128, 130 can be gathered, in particular, from the illustration as per FIG. 2, which shows the cleaning and disinfection instrument 110 with a closed front-side hinged door 114. The care utensils or the goods to be cleaned, for example the bedpan 120 and the urinal bottle 122, are held in this position by the vessel holder 116 such that said care utensils can be emptied and cleaned. In the figures, the emergence of jets of the cleaning fluid is illustrated schematically at the nozzles 128, 130.

While the nozzles 128 can, for example, emit a plurality of fan-shaped jets or can otherwise cover a relatively large angular range, the nozzle 130 designed for cleaning the interior of the care utensils 118, e.g. the urinal bottle 122, emits one or more comparatively focused jets 132. In the following text, the assumption is made that this is a single jet 132, with other embodiments however also being possible. Here, the jet 132 is emitted by the nozzle 130 such that said jet is emitted in a jet direction at which the jet 132, after passing through a neck, impinges on a base or a standing surface of the urinal bottle 122 on the inside. There the jet 132 splashes such that the cleaning fluid, as illustrated symbolically in FIG. 2, is distributed over the entire interior surface of the urinal bottle 122, preferably wetting the latter and hence cleaning it.

Furthermore, the illustration as per FIG. 2 makes it clear that the jet 132 emitted by the nozzle 130 for interior cleaning must preferably be comparatively narrow and must be aligned relatively precisely with respect to the care utensils 118, for example with respect to the urinal bottle 122, such that the cleaning fluid can reach the base of the care utensils. If the jet 132 were already to impinge on the inside of the neck or the side surfaces of the urinal bottle 122, the cleaning fluid could no longer advance to the base surface, with the result that parts of the inner surfaces of the urinal bottle 122 would not be cleaned.

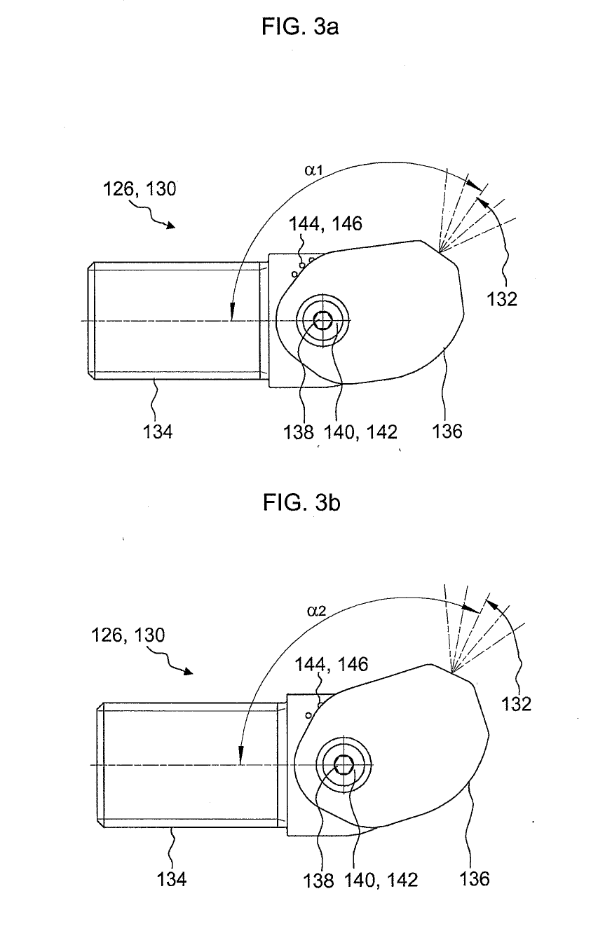

FIGS. 3a and 3b show a side view of an exemplary, embodiment of the nozzle 130, which, for example, can be used as per FIGS. 1 and 2 for cleaning the interior of care utensils 118, such as urinal bottles 122. In this exemplary embodiment, the nozzle 130 comprises a nozzle assembly 134, which can for example be fixedly mounted on a wall of the washing chamber 112. A nozzle head 136, as an adjustable part, is mounted on this nozzle assembly 134, which acts as fixed part of the nozzle 130. In the illustrated exemplary embodiment, this nozzle head 136 is mounted such that its angle about a single pivot axis 138 can change. This can adjust an angular position of the jet 132, which is denoted by α1 and α2 in FIGS. 3a and 3b. Here, FIG. 3a shows an angle α1, which is greater than the angle α2 illustrated in FIG. 3b. In principle, an adjustment about a plurality of pivot axes 138 and/or a pivot-axis-free setting is also possible, for example by means of a ball-and-socket joint or similar adjustment devices.

Here, the nozzle head 136 is designed to be adjustable but it can also be fixed. The cleaning fluid is supplied to the nozzle head 136 through a bore arranged in the interior of the nozzle assembly 134 or through a plurality of such bores, which are not illustrated in the figures. The jet 132 is formed in the interior of the nozzle head 136 and is emitted into the washing chamber 112 and onto and/or into the goods to be cleaned in the form of the care utensils 118 in a jet direction predefined by the position of the nozzle head 136. In the case of smaller angles α2, as illustrated in an exemplary fashion in FIG. 3b, the jet 132 is emitted more steeply in an upward direction and, in doing so, for example still reaches the base of the urinal bottle 122, even in more strongly bent urinal bottles 122.

Here, in the illustrated exemplary embodiment, the nozzle 130 comprises a fastener 140, by means of which the position of the jet 132 can be fixed or fastened after it has been set. In FIGS. 3a and 3b, this fastener 140 is illustrated symbolically in the form of a screw 142. However, in principle, other types of fasteners 142 are also possible. Changing the angular position of nozzle assembly 134 and nozzle head 136 is made possible by releasing the fastener 140 or the screw 142, which can, for example, be arranged on the pivot axis 138. After the fastener 140 has been released, the nozzle head 136 can be pivoted relative to the nozzle assembly 134, and so this results in a changed angle α1 or α2. The setting is simplified by allowing the provision of at least one latching device 144 on the nozzle assembly 134 and/or on the nozzle head 136. This latching device can for example also comprise a display, for example in the form of markings 146, which make it possible to identify the current settings of the jet direction of the jet 132.

Once the setting has been undertaken, the fastener 140 can be fixed again, for example by tightening the screw 142. This permanently fixes the nozzle head 136, and so it cannot be adjusted during the operation of the cleaning and disinfection instrument 110.

Other means that satisfy the purpose of fixing are also feasible and can be used as fastener 140 instead of the screw 142. By way of example, use can be made of split pins, pins, union nuts or other types of fasteners 140 or combinations of such fasteners and/or other types of fasteners.

A sealing apparatus, for example in the form of a labyrinth seal, is provided between the nozzle assembly 134 and the nozzle head 136 in order to minimize the loss of cleaning fluid in a possibly occurring gap between these components. This seal can for example comprise grooves and ridges. The labyrinth seal is not illustrated in FIGS. 3a and 3b.

The described procedure for setting the jet direction of the jet 132 can for example be undertaken during an installation of the cleaning and disinfection instrument 110, for example for fitting it to the specific requirements emerging from customer instructions. However, as an alternative or in addition thereto, the procedure for setting can also be undertaken later, for example in situ at a customer, for example if the customer requirements change over the service life.

In principle, the described nozzle 130 can be produced using various methods. By way of example, the nozzle can be made of plastic and/or of metal. By way of example, machining can be used to produce the nozzle 130. In a particularly preferred production method, the individual parts are produced by a plastic injection-moulding method or by similar methods. A further feasible method is the production of the nozzle parts by so-called e-manufacturing methods, i.e. methods in which shaping follows with the aid of 3D data. By way of example, plastic or a metal powder can, in the process, be brought into a desired shape, for example by selective laser sintering (SLS).

Moreover, it should additionally be mentioned that a cleaning and disinfection instrument 110 for medical ware and other types of care utensils 118 may of course also be equipped with a plurality of the above-described adjustable nozzles 130, particularly if the intended application and instrument specification provide for simultaneous cleaning of more than one care utensil, e.g. of more than one urinal bottle and/or other types of vessels.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cleaning and disinfection instrument for cleaning care utensils, the instrument comprising:
a washing chamber configured to hold the care utensils; and
a spray system configured to apply a cleaning fluid onto the care utensils, the spray system comprising at least one nozzle adapted to emit at least one jet of the cleaning fluid, wherein a jet direction, at which the jet is emitted, is settable.

2. The cleaning and disinfection instrument according to claim 1, wherein the jet direction is fixed after being set.

3. The cleaning and disinfection instrument according to claim 1, wherein the nozzle comprises a nozzle assembly, which has at least one bore for supplying the cleaning fluid.

4. The cleaning and disinfection instrument according to claim 1, wherein the nozzle assembly is mounted on an internal wall of the washing chamber.

5. The cleaning and disinfection instrument according to claim 1, wherein the nozzle has an adjustable nozzle head.

6. The cleaning and disinfection instrument according to claim 1, wherein the nozzle has a fastener, with the jet direction being adjustable in at least one first position of the fastener and with the jet direction being fixed in at least one second position of the fastener.

7. The cleaning and disinfection instrument according to claim 6, wherein the fastener has a screw, a split pin, a bolt, a union nut, a detachable latching device, a latching button, a spring-pretensioned latching button, or a quick-release device.

8. The cleaning and disinfection instrument according to claim 6, wherein the is configured to permanently fix the jet direction during operation of the cleaning and disinfection instrument.

9. The cleaning and disinfection instrument according to claim 1, wherein the jet direction is settable over an adjustment range, and wherein the nozzle has at least one latching device via which the nozzle is fixable in a plurality of predefined positions of the jet directions.

10. The cleaning and disinfection instrument according to claim 9, wherein the latching device is configured to subdivide the adjustment range into a plurality of predefined steps.

11. The cleaning and disinfection instrument according to claim 1, wherein the nozzle or a latching device is configured to make a selected position of the jet direction optically detectable.

12. The cleaning and disinfection instrument according to claim 1, wherein the nozzle or a latching device comprises a display that indicates the selected position of the jet direction.

13. The cleaning and disinfection instrument according to claim 1, wherein the nozzle has at least one fixed part, a nozzle assembly, at least one adjustable part, and/or a nozzle head, with at least one labyrinth seal being provided between the fixed part and the adjustable part.

14. The cleaning and disinfection instrument according to claim 1, wherein the nozzle comprises a metallic material and/or a plastic.

15. The cleaning and disinfection instrument according to claim 1, wherein the nozzle is wholly or partly produced by a shaping method, in which bodies are produced directly from three-dimensional computer data.

16. A nozzle for use in a spray system in a cleaning and disinfection instrument according to claim 1, wherein the nozzle is configured to emit at least one jet of a cleaning fluid, in which a jet direction, at which the jet is emitted, is settable and is fixable.
